(19) United States
(12) Patent Application Publication
(10) Pub. No.: US 2009/0209158 A1
(43) Pub. Date: Aug. 20, 2009

(54) Pelletized Polymer Product And Process For Making The Same

(76) Inventors: Galen C. Richeson, Humble, TX (US); Bryan G. Wells, Houston, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/296,562

(22) PCT Filed: Mar. 28, 2007
(86) PCT No.: PCT/US07/07776

§ 371 Date: Apr. 15, 2009

Related U.S. Application Data
(60) Provisional application No. 60/794,926, filed on Apr. 26, 2006.

(51) Int. Cl. D04H 13/00; C08F 10/06; B29B 9/00; B29C 47/00

(52) U.S. Cl. 442/327; 525/333.7; 264/5; 264/176.1

(57) ABSTRACT

Provided is a propylene polymer composition comprising a neat polymer and a hydroxylamine ester compound suitable for preparing low melt viscosity polymers useful in spinning, melt blowing, extruding and the like. The polymer composition exhibits near-neat propylene polymer melt viscosity such that it can be readily pelletized for transport or use by an end user other than the composition manufacturer. Also provided is a process for preparing the polymer composition, pelletizing it, melt mixing the composition pellets at a temperature and for a time sufficient to allow viscosity breaking of the composition, and melt blowing or spunbonding the resulting low melt viscosity polymer to produce high quality non-woven fabrics. Finally, a non-woven fabric with superior barrier properties made from the polymer composition is provided.

### CROSS REFERENCE TO RELATED APPLICATIONS

This application claims the benefit of Provisional Application No. 60/794,926, filed Apr. 26, 2006, the disclosure of which is incorporated by reference in its entirety.

### FIELD OF THE INVENTION

The present invention relates to a pelletized polymer composition for use in melt-spinning, spunbonding, melt blowing, centrifugal spinning, sheet slitting, film fibrillation, extruding and the like.

### BACKGROUND OF THE INVENTION

Ultra-low melt viscosity polymers, such as propylene and butylene polymers, are known to be useful for the production of such products as adhesives, sealants, coatings, non-woven fabrics produced by melt blown fiber processes, injection-molded components made at a high rate, deep draw stampable reinforced thermoplastic components and others.

Production of ultra-low melt viscosity (“ULMV”) polymers by direct polymerization processes is, however, problematic. Due to their particular nature, such polymers can require complex and costly operations primarily in relation to the separation of ULMV polymers from the solvents in which the monomers are dissolved to facilitate the polymerization process. ULMV resins produced by in-reactor processes are supplied in a flake rather than pellet form, owing to the difficulty in pelletizing them. The flake form often results in the presence of a significant amount of powdery fines, creating difficulties in handling and transporting the material.

It is also known to produce relatively high melt viscosity polymers according to usual polymerization processes and then subject the polymer to a thermomechanical degradation process in the presence of a free radical generator. In theory, during this degradation, the free radical generator, such as a peroxide or hydroxylamine ester, thermally degrades permitting the resulting free radical to break the macromolecular bonds of the polymer. This results in a polymer with lower average molecular weight, narrower molecular weight distribution (“MWD”) and most importantly, a lower melt viscosity (and higher melt flow rate). Producing an ULMV polymer by this process is often called viscosity breaking or vis-breaking the polymer, and the free radical generator is often referred to as a viscosity breaking or vis-breaking agent.

Pelletization of thermoplastic materials is of great importance for many applications, particularly when the end user of the pellets is not the manufacturer of the polymer, thus necessitating shipment of the material. Pellets readily flow in measuring and dispensing apparatus and the size of pellet charges can be readily controlled with great accuracy. Pelletization of ULMV polymers, however, is difficult. See U.S. Pat. Nos. 4,451,589; 4,897,452 and 5,594,074. ULMV polymers, upon leaving a pelletizing extruder are often in such a fluid and soft form that they are difficult or even impossible to cut into pellet form. Those pellets that can be formed may be non-uniform, sticky and have a tendency to agglomerate, thereby frustrating future processors. Non-uniform pellets of ULMV polymer may be described by such terms as “tailed pellets,” “long-string pellets,” “elbows,” “dog bones” and “pellet trash,” while the agglomerated pellets may be described by such terms as “pellet marriages.” Additionally, ULMV polymer buildup on the pelletizer's rotating blades frequently results in unscheduled shutdowns, resulting in unacceptably low production rates and high maintenance costs. Further, the malformed pellets exhibit many characteristics undesirable among end-users, including altered bulk density of pellet stock (resulting in processing voids or inaccurate composition formulations), bridging or other feed problems in extrusion lines and incompatibility with existing conveyor-style transport devices. Finally, polymer production systems require long time periods to transition (hereinafter, “transition times”) from production of low melt flow rate polymer production to high melt flow rate polymer production. Long transitions times limit production efficiencies and result in the production of intermediate melt flow rate polymers with limited usefulness.

To avoid these problems, known processing techniques have used multi-step degradation processes wherein a vis-breaking agent is added to a polymer and the polymer is then pelletized. The processing and pelletization is conducted under conditions that provide a substantial amount of unreacted vis-breaking agent impregnated in the polymer pellet, but, unfortunately often resulting in some vis-breaking of the polymer. Later processing by an end-user activates the remaining impregnated vis-breaking agent, thereby producing an ULMV polymer suitable for melt blown or other processes. U.S. Pat. Nos. 5,594,074, 4,451,589 and 4,897,452 all describe processes for making polymer pellets containing an unreacted free radical generator. The processes of these three patents (more fully described below) use (1) a single vis-breaking agent added to the polymer at a single location along the length of an extruder, (2) a single vis-breaking agent that is added in two or more locations in the process, one near the feed throat of the pelletizing extruder and another near the exit or (3) two vis-breaking agents with significantly different half-lives added at different locations in the pelletizing process.

A single agent, single addition process is described in U.S. Pat. No. 4,451,589. This process involves controlling the temperature and residence time in the pelletizing extruder to limit the activity of the vis-breaking agent prior to pelletizing. A single agent, multiple addition process is described in U.S. Pat. No. 5,594,074. By making a second addition of vis-breaking agent near the exit of the pelletizing extruder and then quickly quenching the resulting pellets, the vis-breaking agent does not have sufficient time or thermal energy to degrade the polymer before quenching and remains available for further polymer degradation in later processing. The two agent process is described in U.S. Pat. No. 4,897,452. This process uses two vis-breaking agents, one with a half life significantly longer than the other. By utilizing the shorter half-life agent early in the pelletizing process, the polymer is partially degraded. When the second, longer half-life agent is added to the polymer just before pelletizing, that agent does not have sufficient residence time in the pelletizing extruder at sufficient temperature to degrade the polymer before quenching and remains available for further polymer degradation in later processing.

Another known method for producing low melt viscosity resins consists of coating higher melt viscosity polymer granules with peroxide so they crack to lower melt viscosity during subsequent processing. However, this method is disadvantageous in that the shelf-life of peroxide coated polymer granules (“PCGs”) is insufficient to allow for long term storage or long distance transport of the PCGs from producer to end user.

Both flake form resin and PCGs present difficulties for the operations of many downstream processors through (1) incompatibility with material transport systems (i.e. conveyors), (2) end-user equipment that is not suited to processing polymer granules, but is rather, designed to process the much more widely used pellet form of polymer (resulting in lower through-put rates when granules are used instead of pellets), and (3) oxidation of the neat polymer by virtue of uneven distribution of stabilizer additives and the high surface-to-volume ratio of flakes and PCGs.

While many of the patents discussed herein describe the use of peroxide to decrease a polymer's melt viscosity, it is known to utilize hydroxylamine esters in much the same way. Hydroxylamine esters exhibit certain advantages over peroxides, including being safer and easier to handle and presenting less of a fire and explosion hazard. Additionally, hydroxylamine esters are, generally, more stable at higher temperatures than peroxides and thus, capable of being used to form vis-breaking agent impregnated pellets at standard polymer processing temperatures with minimal impact on the melt viscosity of the base polymer.

Many known processes for vis-breaking polymers start with usual reactor-grade polymer with a melt flow rate of between about 0.01 and 35 dg/min. Vis-breaking such a polymer to achieve a polymer capable of producing high quality melt blown fabrics (e.g. melt flow rate=350-3500 dg/min) often results in creation of excessive quantities of oligomers in the ULMV polymer product. The presence of oligomers in melt blown and other processes that utilize ULMV polymers can cause (1) smoking, thereby imparting undesirable color or odor to the final article formed from the ULMV polymer, (2) oil and wax build-up and (3) may shorten the useful life of the melt blown die tip. Further, non-woven fabrics made from ULMV polymers with excessive quantities of oligomers can have levels of extractables that exceed regulatory limits (such as those promulgated by the United States Food and Drug Administration).

It would, therefore, be desirable to have a pelletized product that is compatible with existing material transport systems, does not suffer significant impairment of activity from exposure to air, exhibits long term shelf stability, is readily produced through existing polymerization techniques without requiring long transition times and, when heated and melt mixed during further processing, is capable of producing a narrow molecular weight distributed, ultra-low melt viscosity polymer containing a low level of oligomers.

### SUMMARY OF THE INVENTION

One aspect of the present invention provides a process for producing a polymer composition comprising the steps of mixing a neat polymer and a hydroxylamine ester compound to form a blend, where the neat polymer exhibits a melt flow rate of 50 dg/min to 400 dg/min, the hydroxylamine ester is present in the range of about 0.01% to about 10% by weight and the blend exhibits a melt flow rate or melt index of not less than that of the neat polymer to about quadruple that of the neat polymer; and pelletizing the blend to form a blend pellet. The blend pellets may be processed further to create fibers and non-woven fabrics with superior barrier properties and low oligomer levels.

Another aspect of the present invention provides a polymer composition comprising a neat polymer and a hydroxylamine ester compound, where the neat polymer exhibits a melt flow rate or melt index of 50 to 400, the hydroxylamine ester is present in the range of about 0.01% to about 10% by weight and the blend exhibits a melt flow rate or melt index of not less than that of the neat polymer to about twice that of the neat polymer.

Yet another aspect of the present invention provides a non-woven fabric exhibiting significantly improved barrier performance as measured by a hydrostatic head to basis weight ratio of at least about 2.5 millibar/gram/meter². In another aspect, the non-woven fabric of the present invention, either alone or in conjunction with other materials, may be used to produce articles, including, but not limited to, surgical gowns, diapers and feminine hygiene or adult incontinence products.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

As used herein, these terms shall mean the following:

High melt viscosity polymer—a polymer with melt viscosity of 1,000,000 centipoise (“cps”) or more;
Ultra-low melt viscosity polymer—a polymer having a melt viscosity of about 300,000 cps or lower;
Neat polymer—a polymer as generated from the polymerization process and isolated from any polymerization solvent, excess monomer, etc. and not yet subjected to post-polymerization treatment to reduce viscosity or narrow the polymer's molecular weight distribution;
Oligomer—a polymer consisting of only a few monomer units such as a dimer, trimer, tetramer, etc., or their mixtures (the upper limit of repeating units in an oligomer shall be about one hundred);
Hydrostatic head (“Hydrohead”)—a measure in millibar (“mbar”) of the liquid barrier properties of a fabric;
Air Permeability—a measure in volume of air per unit time per unit area of fabric of the barrier properties of a fabric; and
Basis weight—a measure in grams per square meter (“gsm”) of the fiber density of a non-woven fabric.

A polymer with a melt viscosity of about 300,000 cps will have a melt flow rate of approximately 100 dg/min, and is generally regarded as an ultra-high melt flow rate polymer. Melt indices (“MI”) and melt flow rates (“MFR”) are determined using a Gottfert Melt Indexer, Model MPE. As used herein, the melt indices are measured by ASTM D1238 condition E at 190 degrees Celsius (“° C.”) and 2.16 kg weight and melt flow rates are measured by ASTM D1238 condition L at 230° C. and 2.16 kg weight.

Hydrohead was determined using a TexTest FX3000 Hydrostatic Head Tester. Samples are clamped into place over a water-filled test head. Water pressure underneath the sample is increased at 60 mbar/min. The test is terminated when three drops of water penetrate the sample. Datum reported is water pressure (in millibar) at termination of the test. Hydrohead testing was conducted per INDA, Association of the Nonwoven Fabrics Industry Corporation (“INDA”) WSP 80.6 (98).

Air Permeability was determined using a TexTest FX 3300 machine with a pressure drop setting of 125 Pa Specimens are clamped into place, and the flow rate of air through the sample is increased until the pressure drop reaches 125 Pa. A measurement is made of the flow rate of air and volume of air per unit area per unit time. This procedure is according to INDA's WSP 70.1 (05) (equivalent to ASTM-D737-96).

Molecular weight distribution Mw/Mn (“MWD”) is the ratio of weight average molecular weight (“Mw” as determined by gel permeation chromatography, hereinafter “GPC”) to number average molecular weight (“Mn” as determined by GPC).

A propylene polymer composition according to the present invention comprises (1) a neat propylene polymer exhibiting a MFR of 50 to 400 dg/min and (2) a viscosity breaking agent, namely a hydroxylamine ester compound, present in the range of about 0.01% to about 10% by weight. The propylene polymer composition should exhibit a MFR of from not less than that of the neat propylene polymer to quadruple that of the neat propylene polymer. For example, if the neat propylene polymer exhibits a MFR of 75 dg/min before mixing with the hydroxylamine ester compound, then the composition of neat propylene polymer and hydroxylamine ester compound should exhibit a MFR of from 75 dg/min to 300 dg/min.

The neat propylene polymer of the present invention may be of any type known in the art for which viscosity breaking would be desirable, including, but not limited to, propylene polymers, propylene copolymers, polypropylene blends, propylene impact copolymers, polypropylene EPR blends, polypropylene EPDM blends, polypropylene elastomers and polypropylene vulcanizates. The neat propylene polymer of the present invention exhibits a MFR of from 50 dg/min to 400 dg/min, more preferably from 50 dg/min to 150 dg/min, even more preferably from 50 dg/min to 100 dg/min, and even more preferably from 50 dg/min to 75 dg/min. The neat propylene polymer may be polymerized using any means known to one of skill in the art for producing propylene polymers with the desired melt flow rates. Additionally, the neat propylene polymer may be mixed with any additive known to one of skill in the art to impart desirable properties to the propylene polymer, including, but not limited to, oxidation stabilizers, acid scavengers, nucleating agents, and UV stabilizers.

The hydroxylamine ester compounds of the present invention may be any of those known in the art for reducing the molecular weight of, or viscosity breaking, polyolefin compounds, particularly propylene polymers, and are generally described in WO 01/90113 A1 by Roth, et al and incorporated herein by reference. A preferable hydroxylamine ester compound is sold commercially by Ciba Specialty Chemicals Corporation. under the trademark Irgatec® CR76. The hydroxylamine ester compound may be present in the range of about 0.01% to about 10% by weight, preferably from about 0.01% to about 7%, more preferably from about 0.01% to about 5%, more preferably from about 0.5% to about 4%, even more preferably from about 1% to about 3%.

In an embodiment, when heated, the propylene polymer composition of the invention exhibits a high MFR (greater than twice that of the neat propylene polymer) and a low level of oligomers. Particular embodiments include, but are not limited to, a heat treated propylene polymer composition exhibiting MFR of from 500 to 1000 dg/min and comprising less than 1% oligomers. In another preferred embodiment, when heated, the propylene polymer composition exhibits a MFR of from 750 to 2000 dg/min and comprises less than 3% oligomers, more preferably a MFR of from 1000 to 3000 dg/min and comprises less than 5% oligomers. Oligomer concentration in a propylene polymer composition may be measured using, among other tests known to those of skill in the art, a hexane extractables test (ASTM D5227-01).

A non-woven fabric according to the current invention comprises a propylene polymer composition as described above and exhibits a hydrohead to basis weight ratio of at least 2.5 mbar/gsm, preferably at least 3.0 mbar/gsm, more preferably at least 3.5 mbar/gsm and even more preferably at least 4.0 mbar/gsm. The non-woven fabric propylene polymer compound comprises a neat propylene polymer exhibiting a MFR of 50 to 200 dg/min and a hydroxylamine ester compound present in the range of about 0.01% to about 10% by weight. Further, the non-woven fabric propylene polymer compound, when maintained below an activation temperature, exhibits a MFR of not less than that of the neat propylene polymer to about quadruple that of the neat propylene polymer. When heated above the activation temperature, the non-woven fabric propylene polymer compound exhibits a MFR of from about twice that of the neat propylene polymer to about 3500 dg/min.

In one embodiment of the non-woven fabric, the propylene polymer composition that comprises the non-woven fabric, when heated to the activation temperature for a length of time, exhibits a MFR of from 500 to 1000 dg/min and comprises less than 1% oligomers; in another embodiment, a MFR of 1000 to 3000 dg/min and comprises less than 5% oligomers; in yet another embodiment, a MFR of 750 to 2000 dg/min and comprises less than 3% oligomers. The activation temperature is a temperature at which the hydroxylamine ester compound of the propylene polymer composition is capable of effectuating substantial amounts of propylene polymer chain breaking to achieve a lower melt viscosity polymer. The hydroxylamine ester compound will often exhibit some viscosity breaking ability below the activation temperature. The activation temperature may be, in one embodiment, about 300° C., in another about 280° C., in another about 260° C. and in yet another embodiment, about 240° C.

A process for preparation of propylene polymer blends according to the current invention involves first, mixing a neat propylene polymer and a viscosity breaking agent, namely a hydroxylamine ester compound, to form a blend. Mixing of the neat propylene polymer and viscosity breaking agent may be by any method known in the art for combining thermoplastic polymers and additive materials, for example, melt mixing in an extruder. Examples of extruders that may be used in the present invention are a planetary extruder, single screw extruder, co- or counter rotating multi-screw screw extruder, co-rotating intermeshing extruder or ring extruder. The viscosity breaking agent may be introduced to the propylene polymer as a neat formulation (high concentration, with few or no additional materials), a dilute solution, a master batch (pre-compounded with a polymeric material the same as, similar to or compatible with the neat propylene polymer), or any other form known to one of skill in the art for mixing additives with thermoplastic polymers.

After mixing, the blend should exhibit a MFR of from not less than that of the neat propylene polymer to quadruple that of the neat propylene polymer. For example, if the neat propylene polymer exhibits a MFR of 75 dg/min before mixing, then the blend of neat propylene polymer and hydroxylamine ester compound would exhibit a MFR of from 75 dg/min to 300 dg/min. In order that the blend exhibit a near-neat polymer melt viscosity (as measured by MFR), the temperature at which the mixing and pelletizing steps occur must be controlled to prevent substantial activation of the hydroxylamine ester viscosity breaking compound. In one embodiment, it is preferred that the mixing and pelletizing steps occur at a temperature not greater than 250° C., in another embodiment not greater than 240° C., in yet another embodiment, not greater than 230° C., and in yet another embodiment, not greater than 220° C. As discussed herein, in theory, the viscosity breaking agent thermally degrades upon heating to form a free radical species that breaks the macromolecular polymeric bonds to create lower molecular weight polymers, resulting in a lower melt viscosity polymer. Therefore, in one embodiment, it is preferred that the mixing and pelletizing steps occur at a temperature below that which substantially thermally degrades the hydroxylamine ester compound used in the present invention.

Once mixed, the blend is pelletized. In one embodiment, after pelletizing, the blend pellets are heated in a separate fabrication process to activate the viscosity breaking agent and create a high MFR polymer extrudate. In one embodiment, the high MFR polymer extrudate exhibits a MFR of from about 500 dg/min to about 3500 dg/min, or from about 1000 dg/min to about 2500 dg/min, or from about 1500 dg/min to about 2000 dg/min. In another embodiment, the high MFR polymer extrudate comprises less than 7.5% oligomers by weight, preferably less than 5%, more preferably less than 3%, even more preferably less than 2%. In a further embodiment, the high MFR polymer extrudate exhibits a MWD of from about 1.5 to about 7, preferably from 1.5 to 4, more preferably from 1.5 to 3, even more preferably from 1.5 to 2.5.

In another embodiment, fibers are created from the high MFR polymer extrudate. These fibers may be made by any process known to those of skill in the art, including, but not limited to pneumatic drawing, mechanical drawing, melt spinning, melt blowing, spunbonding, centrifugal spinning, sheet slitting and film fibrillation. Further, a fabric may be formed from the extrudate fibers by processes known to those of skill in the art, such as melt blowing and spunbonding.

In accordance with the present invention, any values or ranges of MFR for a particular polymer, polymer composition (either before or after vis-breaking) or extrudate may, alternatively, be referenced with respect to MI under the conditions as defined herein.

In yet other embodiments, the present invention includes:
1. A process for making propylene polymer pellets comprising:
   mixing a neat propylene polymer and a hydroxylamine ester compound to form a blend, where the neat propylene polymer exhibits a MFR of from 50 dg/min to 400 dg/min; the hydroxylamine ester compound is present in the range of about 0.01% to about 10% by weight; and the blend exhibits a MFR of from not less than that of the neat propylene polymer to quadruple that of the neat propylene polymer, and pelletizing the blend in a pelletizer to form blend pellets.
2. The process of embodiment 1, further comprising:
   heating the blend pellets to form a high MFR polymer, where the high MFR polymer exhibits a MFR of about 400 to about 3500 dg/min.
3. The process of embodiment 2, wherein the high MFR polymer exhibits a MWD of 1.5 to 7.
4. The process of embodiments 2 or 3, wherein the high MFR polymer comprises less than 7.5% oligomers by weight.
5. The process of embodiments 1, 2, 3 or 4, further comprising:
   creating fibers from the high MFR polymer.
6. The process of embodiment 5 wherein the fibers are created using a process selected from pneumatic drawing, mechanical drawing, melt spinning, melt blowing, spunbonding and centrifugal spinning.
7. The process of embodiments 5 or 6, further comprising:
   creating a non-woven fabric from the fibers.
8. The process of embodiment 7 wherein the non-woven fabric is created using a process selected from melt blowing and spunbonding.
9. The process of embodiments 7 or 8, wherein the non-woven fabric exhibits a hydrohead to basis weight ratio of at least 2.5 cm/gsm.
10. The process of any of the preceding embodiments, wherein the neat propylene polymer is selected from the group consisting of propylene polymers, propylene copolymers, polypropylene blends, propylene impact copolymers, polypropylene EPR blends, polypropylene EPDM blends, polypropylene elastomers and polypropylene vulcanizates.
11. The process of any of the preceding embodiments, wherein the mixing and pelletizing steps occur at a temperature below that which substantially thermally degrades the hydroxylamine ester compound.
12. A propylene polymer composition comprising a neat propylene polymer and a hydroxylamine ester compound, where the neat propylene polymer exhibits a MFR of from 50 to 400 dg/min; the hydroxylamine ester compound is present in the range of about 0.01% to about 10% by weight; and the propylene polymer composition exhibits a MFR of from not less than that of the neat propylene polymer to quadruple that of the neat propylene polymer.
13. The propylene polymer composition of embodiment 12, wherein the neat propylene polymer is selected from the group consisting of propylene polymers, propylene copolymers, polypropylene blends, propylene impact copolymers, polypropylene EPR blends, polypropylene EPDM blends, polypropylene elastomers and polypropylene vulcanizates.
14. The propylene polymer composition of embodiments 12 or 13, wherein when heated, the propylene polymer composition exhibits a MFR of from 400 to 3000 dg/min and comprises less than 7% oligomers.
15. A non-woven fabric comprising a propylene polymer composition, wherein the non-woven fabric exhibits a hydrohead to basis weight ratio of at least 2.5 cm/gsm, the propylene polymer composition comprising a neat propylene polymer and a hydroxylamine ester compound, where the neat propylene polymer exhibits a MFR of from 50 to 400 dg/min; the hydroxylamine ester compound is present in the range of about 0.01% to about 10% by weight; and the propylene polymer composition exhibits a MFR of from not less than that of the neat propylene polymer to quadruple that of the neat propylene polymer when maintained below an activation temperature, and from about quadruple that of the neat propylene polymer to about 3500 dg/min when heated above the activation temperature.
16. The non-woven fabric of embodiment 15, wherein the neat propylene polymer is selected from the group consisting of propylene polymers, propylene copolymers, polypropylene blends, propylene impact copolymers, polypropylene EPR blends, polypropylene EPDM blends, polypropylene elastomers and polypropylene vulcanizates.
17. The non-woven fabric of embodiments 15 or 16, wherein when heated to at least the activation temperature, the propylene polymer composition exhibits a MFR of about 400 to about 3500 dg/min and comprises less than 7% oligomers.
18. The non-woven fabric of embodiments 15, 16 or 17, wherein the activation temperature is about 280° C.
19. The non-woven fabric of embodiments 15, 16, 17 or 18, wherein the hydrohead to basis weight ratio is at least 3.0 cm/gsm.

### EXAMPLES

Neat propylene polymers as described below were melt mixed with an Irgatec® CR76 masterbatch providing a hydroxylamine ester compound in the amount specified in each example. The resulting propylene polymer compositions were extruded and pelletized at approximately 215° C. Each propylene polymer composition was then melt blown on a Reifenhauser Bicomponent Melt Blowing Line (the “Reifenhauser Line”) employing two 50 mm extruders and equipped with a 600 mm die having 805 holes, each 0.4 mm in diameter. The molten polymer streams from each extruder are combined before passing to the die. Residence time in the extruders is approximately twenty minutes. Hot air is distributed on each side of the die, uniformly extending the molten polymer before it is quenched to a solid fiber. The fibers are collected on a moving screened belt. The die to collector distance (“DCD”) may be adjusted through vertical displacement of the equipment frame, and was optimized during the tests.

### Example 1

A metallocene-catalyzed neat propylene polymer having MFR of 88.3 dg/min was melt mixed with 1.5% by weight of neat polymer of Irgatec® CR76 masterbatch containing a hydroxylamine ester compound. The propylene polymer composition exhibited minimal change in melt viscosity, the composition having a MFR of 104 dg/min.

Melt blowing of the composition was undertaken with residence time of approximately twenty minutes to form a non-woven fabric. The DCD was 198 mm. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 249 | 0.6 | 445 | 24.2 | 16.0 | 134.4 |
| 265 | 0.5 | 943 | 25.1 | 83.3 | 46.5 |
| | 0.6 | 908 | 24.3 | 67.3 | 55.8 |
| | 0.8 | 635 | 24.0 | 42.5 | 68.0 |
| 282 | 0.5 | — | 25.4 | 56.1 | 38.2 |
| | 0.6 | 1829 | 25.0 | 40.4 | 48.0 |
| | 0.8 | — | 24.4 | 31.0 | 64.7 |

### Example 2

A Ziegler-Natta-catalyzed neat propylene polymer having MFR of 150 dg/min was melt mixed with 2.0% by weight of neat polymer of Irgatec® CR76 masterbatch containing a hydroxylamine ester compound. The propylene polymer composition exhibited only a small change in melt viscosity, the composition having a MFR of 383 dg/min.

The composition was melt blown with a DCD of 200 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 249 | 0.5 | — | 24.8 | 46.4 | 84 |
| | 0.6 | — | 24.6 | 22.6 | 129 |
| 266 | 0.5 | — | 25.3 | 72.8 | 53 |
| | 0.6 | — | 24.6 | 66.5 | 57 |
| | 0.8 | — | 24.5 | 49.9 | 73 |
| 271 | 0.5 | — | 24.6 | 80.8 | 43 |
| | 0.6 | — | 24.5 | 66.1 | 58 |
| | 0.8 | — | 24.7 | 43.6 | 67 |

### Example 3

A Ziegler-Natta-catalyzed neat propylene polymer having MFR of 150 dg/min was melt mixed with 1.5% by weight of neat polymer of Irgatec® CR76 masterbatch containing a hydroxylamine ester compound. The propylene polymer composition exhibited only a small change in melt viscosity, the composition having a MFR of 288 dg/min.

The composition was melt blown with a DCD of 200 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 249 | 0.5 | — | 24.7 | 26.9 | 113.2 |
| | 0.6 | 676 | 24.6 | 19.3 | 159.7 |
| 266 | 0.5 | 1608 | 25.3 | 78.1 | 51.4 |
| | 0.6 | 1396 | 246 | 62.0 | 64.6 |
| | 0.8 | 1111 | 25.3 | 50.5 | 68.3 |
| 277 | 0.5 | 2489 | 25.3 | 100.3 | 36.0 |
| | 0.6 | 2679 | 25.2 | 94.0 | 33.5 |
| | 0.8 | 2722 | — | 60.4 | 47.5 |

### Example 4

A Ziegler-Natta-catalyzed neat propylene polymer having MFR of 150 dg/min was melt mixed with 1.5% by weight of neat polymer of Irgatec® CR76 masterbatch containing a hydroxylamine ester compound. The propylene polymer composition exhibited only a small change in melt viscosity, the composition having a MFR of 288 dg/min.

The composition was melt blown with a DCD of 200 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 267 | 0.5 | — | 24.9 | 68.9 | 55.9 |
| | 0.6 | 1837 | 24.0 | 64.3 | 64.0 |
| | 0.8 | — | 24.4 | 57.3 | 747 |
| 274 | 0.5 | 2039 | 24.8 | 77.1 | 46.1 |
| | 0.6 | 2063 | 24.7 | 65.5 | 51.2 |
| | 0.8 | 1732 | 24.8 | 49.9 | 62.6 |
| 282 | 0.5 | 2667 | 24.7 | 96.0 | 30.8 |
| | 0.6 | 2540 | 24.3 | 75.8 | 39.1 |
| | 0.8 | 2305 | 24.1 | 50.0 | 46.9 |

### Example 5

A Ziegler-Natta-catalyzed neat propylene polymer having MFR of 150 dg/min was melt mixed with 1.0% by weight of neat polymer of Irgatec® CR76 masterbatch containing a hydroxylamine ester compound. The propylene polymer composition exhibited only a small change in melt viscosity, the composition having a MFR of 330 dg/min.

The composition was melt blown with a DCD of 200 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 249 | 0.6 | 709 | 23.0 | 15.9 | 206.1 |
| 266 | 0.5 | — | 24.7 | 74.8 | 53.5 |
| | 0.6 | 1248 | 24.9 | 68.8 | 56.3 |
| | 0.8 | — | 25.3 | 47.6 | 65.8 |
| 282 | 0.5 | 1965 | 24.7 | 82.5 | 46.9 |
| | 0.6 | 1898 | 24.6 | 82.3 | 40.1 |
| | 0.8 | 2112 | 25.1 | 59.4 | 45.6 |

### Example 6

A Ziegler-Natta-catalyzed neat propylene polymer having MFR of 60 dg/min was melt mixed with 1.5% by weight of neat polymer of Irgatec® CR76 masterbatch containing a hydroxylamine ester compound. The propylene polymer composition exhibited only a small change in melt viscosity, the composition having a MFR of 105 dg/min.

The composition was melt blown with a DCD of 200 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 266 | 0.5 | — | 24.5 | 59.5 | 67 |
| | 0.6 | — | 24.5 | 53.4 | 69 |
| | 0.8 | — | 24.5 | 36.9 | 80 |
| 282 | 0.5 | — | 24.5 | 64.0 | 45 |
| | 0.6 | — | 24.8 | 56.5 | 46 |
| | 0.8 | — | 25.3 | 53.9 | 52 |

### Example 7

A Ziegler-Natta-catalyzed neat propylene polymer having MFR of 60 dg/min was melt mixed with 2.0% by weight of neat polymer of Irgatec® CR76 masterbatch containing a hydroxylamine ester compound. The propylene polymer composition exhibited only a small change in melt viscosity, the composition having a MFR of 115 dg/min.

The composition was melt blown with a DCD of 200 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 266 | 0.5 | — | 25.0 | 64.6 | 59 |
| | 0.6 | — | 25.2 | 61.1 | 66 |
| | 0.8 | — | 25.2 | 31.5 | 82 |
| 277 | 0.5 | — | 24.2 | 83.9 | 44 |
| | 0.6 | — | 24.6 | 72.4 | 51 |
| | 0.8 | — | 24.5 | 58.4 | 57 |
| 282 | 0.8 | — | 25.4 | 37.0 | 57 |

### Comparative Examples

Each comparative propylene polymer was melt blown on a Reifenhauser Bicomponent Melt Blowing Line employing two 50 mm extruders and equipped with a 600 mm die having 805 holes, each 0.4 mm in diameter. The molten polymer streams from each extruder are combined before passing to the die. Residence time in the extruders is approximately twenty minutes. Hot air is distributed on each side of the die, uniformly extending the molten polymer before it is quenched to a solid fiber. The fibers are collected on a moving screened belt. The die to collector distance may be adjusted through vertical displacement of the equipment frame, and was optimized during the test.

### Comparative Example 1

A PCG, available commercially from ExxonMobil Chemical Company under the trade name PP3746G, was processed and melt blown on the Reifenhauser line.

Melt blowing of the composition was undertaken with residence time of approximately twenty minutes to form a non-woven fabric. The DCD was 198 mm. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 266 | 0.5 | — | 24.3 | 63.1 | 59.1 |
| | 0.6 | 1951 | 24.2 | 60.1 | 66.3 |
| | 0.8 | — | 24.6 | 50.4 | 67.6 |

### Comparative Example 2

A polypropylene homopolymers PGC, available commercially from ExxonMobil Chemical Company under the trade name PP3746G, having nominal vis-broken MFR of 1475 dg/min was processed and melt blown on the Reifenhauser line.

Melt blowing of the composition was undertaken with residence time of approximately twenty minutes to form a non-woven fabric. The DCD was 198 mm. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 249 | 0.5 | 1807 | 24.5 | 75.6 | 55.0 |
| | 0.6 | 1798 | 24.6 | 74.8 | 52.0 |
| | 0.8 | 1825 | 24.5 | 58.9 | 54.0 |
| 266 | 0.5 | 1903 | 24.4 | 83.9 | 43.0 |
| | 0.6 | 1862 | 24.6 | 70.8 | 47.0 |
| | 0.8 | 1852 | 24.9 | 54.3 | 49.0 |
| 282 | 0.5 | 2195 | 25.0 | 66.3 | 42.0 |
| | 0.6 | 2240 | 24.6 | 63.6 | 39.0 |
| | 0.8 | 2094 | 24.3 | 48.6 | 50.0 |

### Comparative Example 3

A neat polypropylene polymer, available commercially from ExxonMobil Chemical Company under the trademark Escorene® PP3155, having nominal MFR of 36 dg/min was melt mixed with 1.5% by weight of neat polymer of Irgatec® CR76 masterbatch containing a hydroxylamine ester compound.

The composition was melt blown with a DCD of 198 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 266 | 0.5 | — | 24.2 | 30.6 | 121 |
| | 0.6 | 326 | 24.5 | 25.6 | 167 |
| | 0.8 | — | 24.2 | 16.1 | 314 |
| 282 | 0.5 | 1127 | 25.2 | 84.4 | 39 |
| | 0.6 | 970 | 23.9 | 79.1 | 41 |
| | 0.8 | 753 | 24.0 | 53.9 | 53 |
| 293 | 0.6 | 1753 | 24.3 | 45.3 | 37 |

### Comparative Example 4

A neat polypropylene polymer, available commercially from ExxonMobil Chemical Company under the trade name PP3155, having nominal MFR of 36 dg/min was melt mixed with 2.0% by weight of neat polymer of Irgatec® CR76 masterbatch containing a hydroxylamine ester compound.

The composition was melt blown with a DCD of 198 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 266 | 0.5 | — | 25.0 | 25.5 | 88 |
| | 0.6 | 360 | 24.2 | 19.3 | 102 |
| | 0.8 | — | 24.0 | 14.4 | 153 |
| 282 | 0.5 | 1356 | 24.8 | 100.5 | 33 |
| | 0.6 | 1206 | 24.3 | 84.4 | 40 |
| | 0.8 | 964 | 24.0 | 62.0 | 49 |

### Comparative Example 5

A neat polypropylene polymer, available commercially from ExxonMobil Chemical Company under the trade name PP3155, having nominal MFR of 36 dg/min was melt mixed with 2.5% by weight of neat polymer of Irgatec® CR76 masterbatch containing a hydroxylamine ester compound.

The composition was melt blown with a DCD of 198 mm to form a non-woven fabric. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 266 | 0.5 | — | 24.9 | 25.1 | 77 |
| | 0.6 | 439 | 24.3 | 22.9 | 85 |
| 282 | 0.5 | 1830 | 24.6 | 82.9 | 33.3 |
| | 0.6 | 1494 | 24.3 | 92.4 | 37.1 |
| | 0.8 | 1410 | 24.2 | 59.9 | 24.0 |

### Comparative Example 6

A neat polypropylene, available commercially from ExxonMobil Chemical Company under the trademark Achieve® 6936G1, having nominal MFR of 1500 dg/min was processed and melt blown on the Reifenhauser line.

Melt blowing of the composition was undertaken with residence time of approximately twenty minutes to form a non-woven fabric. The DCD was 200 mm. The following table provides a summary of the properties of the melt blown fabric produced during the test.

| | | Final | Fabric | Fabric | |
|---|---|---|---|---|---|
| Meltblow | Processing | Fabric | Basis | Hydrostatic | Air |
| Temp. | Flowrate | MFR | Weight | Head | Permeability |
| (° C.) | (ghm) | (dg/min) | (gsm) | (mbar) | (ft³/ft²/min) |
| 249 | 0.5 | — | 25.0 | 71.0 | 56.1 |
| | 0.6 | 1917 | 24.6 | 71.5 | 54.9 |
| | 0.8 | 1771 | 24.6 | 61.5 | 59.2 |
| 266 | 0.5 | — | 24.5 | 74.9 | 51.1 |
| | 0.6 | 1766 | 24.7 | 74.6 | 52.0 |
| | 0.8 | — | 24.8 | 57.1 | 52.8 |
| 282 | 0.5 | 1705 | 24.9 | 80.1 | 43.2 |
| | 0.6 | 1863 | 24.6 | 74.8 | 45.4 |
| | 0.8 | 1758 | 25.2 | 50.4 | 46.6 |

1-21. (canceled)

22. A process for making propylene polymer pellets comprising:
mixing a neat propylene polymer and a hydroxylamine ester compound to form a blend, where
the neat propylene polymer exhibits a MFR of from 50 dg/min to 400 dg/min;
the hydroxylamine ester compound is present in the range of about 0.01% to about 10% by weight; and
the blend exhibits a MFR of from not less than that of the neat propylene polymer to quadruple that of the neat propylene polymer; and
pelletizing the blend in a pelletizer to form blend pellets.

23. The process of claim 22, wherein the neat propylene polymer is selected from the group consisting of propylene polymers, propylene copolymers, polypropylene blends, propylene impact copolymers, polypropylene EPR blends, polypropylene EPDM blends, polypropylene elastomers and polypropylene vulcanizates.

24. The process of claim 22, wherein the neat propylene polymer exhibits a MFR of from 75 to 175 dg/min.

25. The process of claim 22, wherein the mixing and pelletizing steps occur at a temperature below that which substantially thermally degrades the hydroxylamine ester compound.

26. The process of claim 22, wherein the mixing and pelletizing steps occur at a temperature not greater than about 250° C.

27. The process of claim 22, further comprising heating the blend pellets to form a high MFR polymer, where the high MFR polymer exhibits a MFR of about 400 to about 3500 dg/min.

28. The process of claim 27, wherein the high MFR polymer exhibits a MFR of about 1000 to about 2500 dg/min.

29. The process of claim 27, wherein the high MFR polymer comprises less than 7.5% oligomers by weight.

30. The process of claim 27, wherein the mixing and pelletizing steps occur at a temperature below that which substantially thermally degrades the hydroxylamine ester compound.

31. The process of claim 27, wherein the mixing and pelletizing steps occur at a temperature not greater than about 250° C.

32. The process of claim 27, further comprising creating fibers from the high MFR polymer.

33. The process of claim 32, further comprising creating a non-woven fabric from the fibers.

34. The process of claim 33, wherein the non-woven fabric exhibits a hydrohead to basis weight ratio of at least 2.5 cm/gsm.

35. A propylene polymer composition comprising a neat propylene polymer and a hydroxylamine ester compound, where
the neat propylene polymer exhibits a MFR of from 50 to 400 dg/min;
the hydroxylamine ester compound is present in the range of about 0.01% to about 10% by weight; and
the propylene polymer composition exhibits a MFR of from not less than that of the neat propylene polymer to quadruple that of the neat propylene polymer.

36. The propylene polymer composition of claim 35, wherein the neat propylene polymer is selected from the group consisting of propylene polymers, propylene copolymers, polypropylene blends, propylene impact copolymers, polypropylene EPR blends, polypropylene EPDM blends, polypropylene elastomers and polypropylene vulcanizates.

37. The propylene polymer composition of claim 35, wherein when heated, the propylene polymer composition exhibits a MFR of from 400 to 1000 dg/min and comprises less than 1% oligomers.

38. A non-woven fabric comprising a propylene polymer composition, wherein the non-woven fabric exhibits a hydrohead to basis weight ratio of at least 2.5 cm/gsm, the propylene polymer composition comprising a neat propylene polymer and a hydroxylamine ester compound, where
the neat propylene polymer exhibits a MFR of from 50 to 400 dg/min;
the hydroxylamine ester compound is present in the range of about 0.01% to about 10% by weight; and
the propylene polymer composition exhibits a MFR of from not less than that of the neat propylene polymer to quadruple that of the neat propylene polymer when maintained below an activation temperature, and from about quadruple that of the neat propylene polymer to about 3500 dg/min when heated above the activation temperature.

39. The non-woven fabric of claim 38, wherein the neat propylene polymer is selected from the group consisting of propylene polymers, propylene copolymers, polypropylene blends, propylene impact copolymers, polypropylene EPR blends, polypropylene EPDM blends, polypropylene elastomers and polypropylene vulcanizates.

40. The non-woven fabric of claim 38, wherein when heated to at least the activation temperature, the propylene polymer composition exhibits a MFR of about 500 to about 1000 dg/min and comprises less than 1% oligomers.

41. The non-woven fabric of claim 38, wherein the activation temperature is about 300° C.

42. The non-woven fabric of claim 38, wherein the hydrohead to basis weight ratio is at least 3.0 cm/gsm.
